(19) United States
(12) Patent Application Publication
(10) Pub. No.: US 2008/0162955 A1
(43) Pub. Date: Jul. 3, 2008

(54) USB HOST, USB DEVICE, AND METHODS OF CONTROLLING THE HOST AND THE DEVICE

(75) Inventor: Ryoichi SHIMIZU, Shiojiri-shi (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Tokyo (JP)

(21) Appl. No.: 11/966,929

(22) Filed: Dec. 28, 2007

(30) Foreign Application Priority Data
Dec. 28, 2006 (JP) 2006-355065

(51) Int. Cl. G06F 13/00; G06F 1/26

(52) U.S. Cl. 713/300; 710/305

(57) ABSTRACT

A USB host includes a first connection unit capable of being connected to and disconnected from one end of a USB cable including two power lines and two signal lines, the other end of the USB cable being connected to a USB device; a first output unit that outputs information through the first connection unit; and a first control unit that causes the first output unit to transmit an instruction to request power supply to the USB device through at least one of the two power lines and the two signal lines in the USB cable and, then, causes the first output unit to transmit information to the USB device with power received from the USB device through the USB cable.

### BACKGROUND OF THE INVENTION

1. Field of the Invention

The present invention relates to a USB host, a USB device, and methods of controlling the host and the device.

2. Description of the Related Art

In a typical Universal Serial Bus (USB) system in related art, a USB device provided with a Mini-B receptacle applies voltage to the ID terminal to which the fifth line in a USB On-The-Go (OTG) cable is connected and supplies power to the VBUS terminal when the ID terminal is short-circuited with the GND line in the cable in a USB host provided with a Mini-A receptacle to allow the USB host to receive the power from the USB device while functioning as the host (for example, refer to Japanese Unexamined Patent Application Publication No. 2005-25405).

However, in the USB system disclosed in Japanese Unexamined Patent Application Publication No. 2005-25405, although the USB device can supply the power to the USB host without conforming to the USB-OTG, it is necessary to provide a receptacle conforming to the USB-OTG or use a plug to be inserted into this receptacle to ensure the fifth ID line serving as a dedicated line for confirming whether power supply is required.

### SUMMARY OF THE INVENTION

Accordingly, it is an object of the present invention to provide a USB host, a USB device, and methods and programs of controlling the USB host and the USB device, the USB device being capable of supplying power to the USB host without providing a dedicated line used for confirming the power supply.

To achieve the above object, the present invention is configured as follows.

In order to achieve the above object, according to an embodiment of the present invention, there is provided a USB host including a first connection unit capable of being connected to and disconnected from one end of a USB cable including two power lines and two signal lines, the other end of the USB cable being connected to a USB device; a first output unit that outputs information through the first connection unit; and a first control unit that causes the first output unit to transmit an instruction to request power supply to the USB device through at least one of the two power lines and the two signal lines in the USB cable and, then, causes the first output unit to transmit information to the USB device with power received from the USB device through the USB cable.

The USB host is connected to one end of the USB cable, the other end of the USB host being connected to the USB device, transmits the instruction to request power supply to the USB device through at least one of the two power lines and the two signal lines in the USB cable, and transmits information to the USB device with the power supplied from the USB device through the USB cable. Since the instruction to request power supply is transmitted through either of the two power lines and the two signal lines, there is no need to provide another line used to request the power supply. Accordingly, it is possible to supply the power from the USB device to the USB host without requiring a dedicated line used for confirming the power supply. The “two power lines” mean the VBUS and GND lines and the “two signal lines” mean the D+ and D− lines. The USB host according to the embodiment of the present invention may include a power supply determining unit that determines whether power is received from the USB device. If the power supply determining unit determines that the power is received from the USB device, the first control unit may cause the first output unit to output the information with the power supplied through the USB cable.

In the USB host, the first connection unit may be capable of being connected to and disconnected from a USB cable only including two power lines and two signal lines.

The USB host may further include a first acquiring unit that acquires information through the first connection unit. The first control unit may cause the first output unit to output an instruction to execute the power supply through the USB cable when the first acquiring unit acquires a response indicating that the USB device can supply the power from the USB device after the first output unit outputs the instruction to request power supply and, then, may cause the first output unit to transmit information to the USB device with the power received from the USB device through the USB cable.

The USB host may further include a first power unit that supplies power from a power source except the USB cable. The first control unit may cause the first output unit to output the information with the power supplied from the first power unit before receiving the power from the USB device through the first connection unit. In this case, the first power unit may supply the power from the primary or secondary battery or may supply the power from a commercial power supply.

The USB host may further include an indicating unit that indicates information to a user. The first control unit may cause the indicating unit to indicate that no power is supplied through the USB cable when no power is supplied from the USB device after the first output unit outputs the instruction to request power supply. In this case, the first control unit may cause the indicating unit to indicate that supply of power other than the power supplied through the USB cable is required when no power is supplied from the USB device after the first output unit outputs the instruction to request power supply.

The USB host may further include an information storage unit that stores processing information used for performing a predetermined process. The first control unit may cause the first output unit to transmit the processing information stored in the information storage unit to the USB device through the first connection unit with the power received from the USB device through the USB cable. The “processing information” includes, for example, image information that is captured by an image pickup apparatus and that is used for performing playback and image information used by a printing apparatus to perform the printing.

According to another embodiment of the present invention, there is provided a USB device including a second connection unit capable of being connected to and disconnected from one end of a USB cable including two power lines and two signal lines, the other end of the USB cable being connected to a USB host; a second acquiring unit that acquires information through the second connection unit; a power supplying unit capable of supplying power through the USB cable; and a second control unit that causes the power supplying unit to supply the power to the USB host through the USB cable after the second acquiring unit acquires an instruction to request power supply from the USB host through at least one of the two power lines and the two signal lines in the USB cable.

The USB device is connected to one end of the USB cable, the other end of the USB cable being connected to the USB host, and supplies the power to the USB host through the USB cable after acquiring the instruction to request power supply through at least one of the two power lines and the two signal lines in the USB cable. Since the instruction to request power supply is acquired through either of the two power lines and the two signal lines, there is no need to provide another line used to acquire the instruction to request power supply. Accordingly, it is possible to supply the power from the USB device to the USB host without requiring a dedicated line used for confirming the power supply.

In the USB device, the second connection unit may be capable of being connected to and disconnected from a USB cable only including two power lines and two signal lines.

The USB device may further include a second output unit that outputs information through the second connection unit. The second control unit may cause the second output unit to transmit a response indicating that the USB device can supply the power to the USB host after the second acquiring unit acquires the instruction to request power supply and, then, may cause the power supplying unit to supply the power to the USB host through the USB cable when the second acquiring unit acquires an instruction to execute the power supply through the USB cable.

The USB device may further include a second power unit that supplies power from a commercial power supply. The second control unit may cause the power supplying unit to stop the power supply from the second power unit through the USB cable until the second acquiring unit acquires the instruction to request power supply from the USB host.

The USB device may further include a print processing unit that prints image information on a recording medium. The second control unit may cause the print processing unit to print image information acquired by the second acquiring unit from the USB host through the second connection unit.

According to another embodiment of the present invention, there is provided a method of controlling a USB host including a first connection unit capable of being connected to and disconnected from one end of a USB cable including two power lines and two signal lines, the other end of the USB cable being connected to a USB device. The method includes the steps of

(a) transmitting an instruction to request power supply to the USB device through at least one of the two power lines and the two signal lines in the USB cable; and
(b) transmitting information to the USB device with power received from the USB device through the USB cable after the step (a).

In the above method of controlling the USB host, one end of the USB cable is connected to the first connection unit, the other end of the USB cable being connected to the USB device, the instruction to request power supply is transmitted to the USB device through at least one of the two power lines and the two signal lines in the USB cable, and information is transmitted to the USB device with the power supplied from the USB device. Since the instruction to request power supply is transmitted through either of the two power lines and the two signal lines, there is no need to provide another line used to request the power supply. Accordingly, it is possible to supply the power from the USB device to the USB host without requiring a dedicated line used for confirming the power supply. The various aspects of the USB host described above may be adopted in the above method and steps for realizing the functions of the USB host may be added to the above method.

According to another embodiment of the present invention, there is provided a method of controlling a USB device including a second connection unit capable of being connected to and disconnected from one end of a USB cable including two power lines and two signal lines, the other end of the USB cable being connected to a USB host. The method includes the steps of

(c) acquiring an instruction to request power supply from the USB host through at least one of the two power lines and the two signal lines in the USB cable; and
(d) supplying power to the USB host through the USB cable after the step (c).

In the method of controlling the USB device, one end of the USB cable is connected to the USB device, the other end of the USB cable being connected to the USB host, the instruction to request power supply is acquired through at least one of the two power lines and the two signal lines in the USB cable, and the power is supplied to the USB host through the USB cable. Since the instruction to request power supply is acquired through either of the two power lines and the two signal lines, there is no need to provide another line used to request the power supply. Accordingly, it is possible to supply the power from the USB device to the USB host without requiring a dedicated line used for confirming the power supply. The various aspects of the USB device described above may be adopted in the above method and steps for realizing the functions of the USB device may be added to the above method.

The programs according to the embodiment of the present invention cause one or more computers to realize the steps in the method of controlling the USB host and the steps in the method of controlling the USB device. The programs may be recorded on a computer-readable recording medium (for example, a hard disk, a read only memory (ROM), a flexible disk (FD), a compact disc (CD), or a digital versatile disk (DVD)), may be distributed from one computer to another computer through a transmission medium (a communication network such as the Internet or a local area network (LAN)), or may be transferred in another form. Executing the programs by one computer or distributing the steps in the programs among multiple computers allows the steps in the above methods to be executed, thus achieving the advantages similar to those of the above methods.

### BRIEF DESCRIPTION OF THE DRAWINGS

FIG. 1 schematically illustrates an example of the configuration of a USB system 10 according to an embodiment of the present invention;

FIG. 2 is a flowchart showing an example of a host-side power reception routine;

FIG. 3 is a flowchart showing an example of a device-side power supply routine; and

FIG. 4 is a sequence chart showing an example of a communication process performed in the USB system.

### DESCRIPTION OF THE PREFERRED EMBODIMENTS

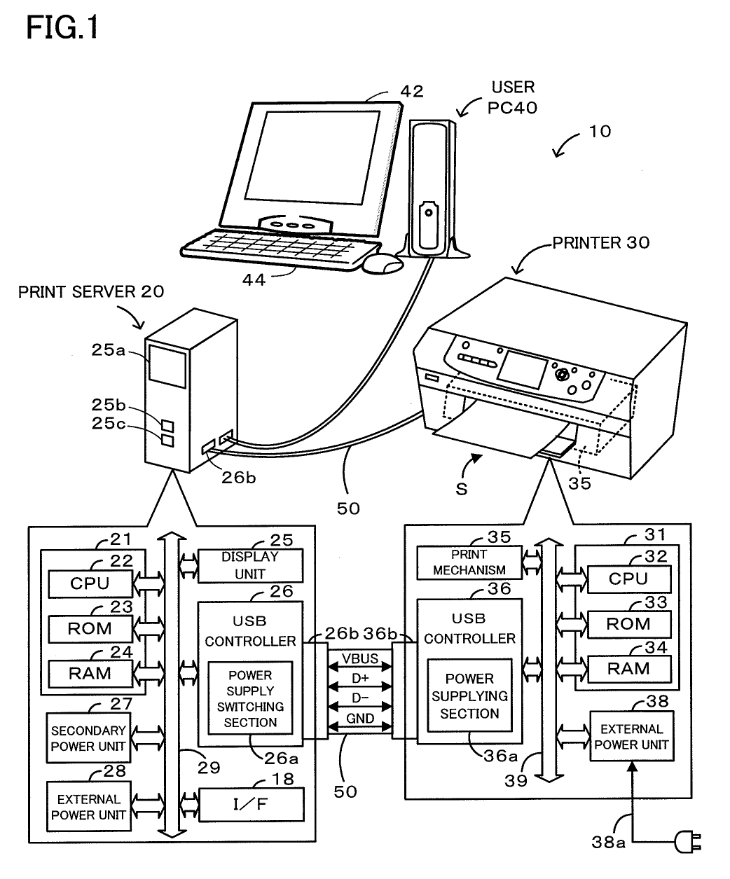

Exemplary embodiments of the present invention will herein be described with reference to the attached drawings. FIG. 1 schematically illustrates an example of the configuration of a USB system 10 according to an embodiment of the present invention. The USB system 10 according to the embodiment of the present invention includes a print server 20 functioning as a USB host, a printer 30, and a user personal computer (hereinafter referred to as a user PC) 40. The printer 30 is connected to the print server 20 via a USB cable 50 and functions as a USB device. For example, the printer 30 prints received print data. The user PC 40 is connected to the print server 20 via a network cable.

The print server 20 transmits print data transmitted from a client, such as the user PC 40, to the printer 30. The print server 20 includes a controller 21, a display unit 25, a USB controller 26, a network interface (I/F) 18, a secondary power unit 27, and an external power unit 28. The controller 21 controls the entire print server 20. The display unit 25 indicates information about the state of the print server 20 to a user by displaying an image or lighting up lamps. The USB controller 26 controls data communication with the USB device (for example, the printer 30) connected to a connection terminal 26b via the USB cable 50. The network I/F 18 is capable of transmitting and receiving information to and from the client connected to a local area network (LAN) serving as a telecommunication line. The secondary power unit 27 temporarily supplies power to the print server 20. Power supplied from an external commercial power supply is supplied to the entire print server 20 through the external power unit 28. Specifically, the controller 21 is a microprocessor mainly including a central processing unit (CPU) 22. The controller 21 also includes a read only memory (ROM) 23 storing various processing programs and a random access memory (RAM) 24 temporarily storing data. The controller 21 is connected to the display unit 25, the USB controller 26, the secondary power unit 27, and the external power unit 28 via a bus 29. The display unit 25 includes a display panel 25a on which characters, graphics, and/or symbols are displayed in response to various instructions, a normal operation lamp 25b lighting up in green during normal operation, and an alarm lamp 25c lighting up in red to call the user's attention. The USB controller 26 includes a power supply switching section 26a that switches the power supply of the print server 20 among the secondary power unit 27, the external power unit 28, and the USB cable 50 connected to the connection terminal 26b. The connection terminal 26b is a USB standard A receptacle connectable only to two power lines including VBUS and GND lines and two signal lines including D+ and a D− lines. The secondary power unit 27 temporarily supplies the power to the entire print server 20, for example, on startup or until the power is supplied through the USB cable 50. The secondary power unit 27 is provided with a removable primary or secondary battery. The external power unit 28 is used when, for example, the power is not supplied through the USB cable 50. A power cord (not shown) can be connected to the external power unit 28.

The printer 30 includes a controller 31, a print mechanism 35, a USB controller 36, and an external power unit 38. The controller 31 controls the entire printer 30. The print mechanism 35 uses ink as a coloring agent to perform printing on recording paper S. The USB controller 36 transmits and receives data to and from the USB host (for example, the print server 20) connected to a connection terminal 36b via the USB cable 50. The external power unit 38 supplies power to the entire printer 30 through a power cord 38a connected to an external commercial power supply. Specifically, the controller 31 is a microprocessor mainly including a central processing unit (CPU) 32. The controller 31 also includes a read only memory (ROM) 33 storing various processing programs and a random access memory (RAM) 34 temporarily storing data. The controller 31 is connected to the print mechanism 35, the USB controller 36, and the external power unit 38 via a bus 39. The print mechanism 35 adopts an ink-jet printing method in which voltage is applied to a piezoelectric element in the print head to deform the piezoelectric element, thereby applying pressure to the ink in the ink cartridge to discharge the ink on the recording paper S. The print mechanism 35 may be an electrophotographic print mechanism. The USB controller 36 controls exchange of information with the USB host connected to the connection terminal 36b via the USB cable 50. The USB controller 36 includes a power supplying section 36a that supplies the power to the USB host connected to the connection terminal 36b via the USB cable 50. The connection terminal 36b is a USB standard B receptacle connectable only to the two power lines including the VBUS and GND lines and the two signal lines including the D+ and a D− lines. The USB cable 50 has a standard A plug at one end and a standard B plug at the other end and includes the two power lines including the VBUS and GND lines and the two signal lines including the D+ and a D− lines.

The user PC 40 is a general-purpose personal computer. The user PC 40 transmits an instruction to print a file to the printer 30 through the print server 20 or receives a response from the printer 30 through the print server 20 by using programs installed in a hard disk drive (HDD) (not shown). The user PC 40 includes a display 42 in which a variety of information is displayed on its screen and an input device 44, such as a keyboard, with which the user inputs various instructions. The user PC 40 has a function of performing an operation in response to a user's operation of, for example, a cursor displayed in the display 42 with the input device 44.

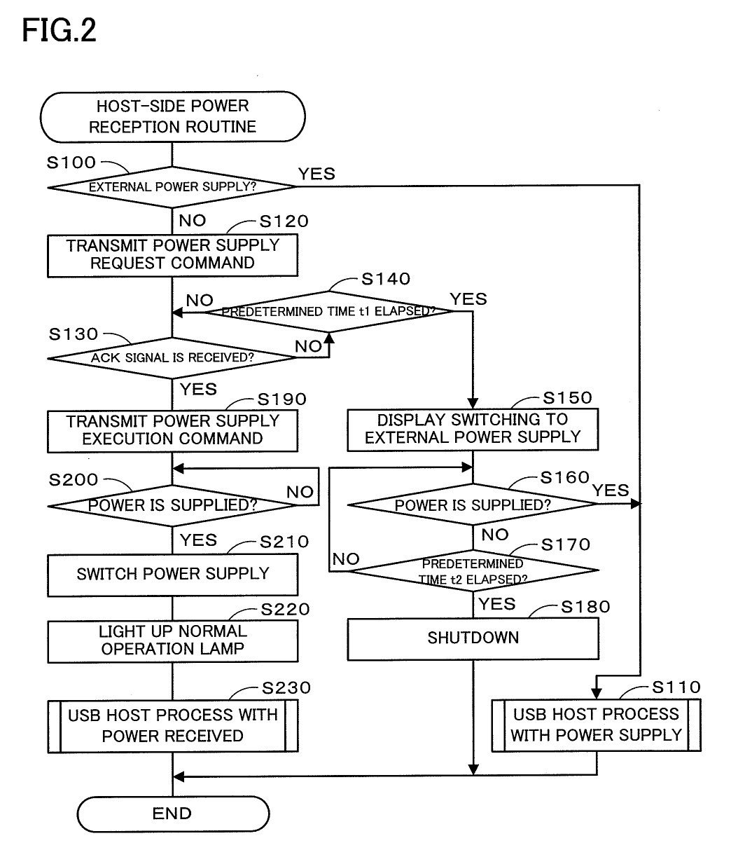

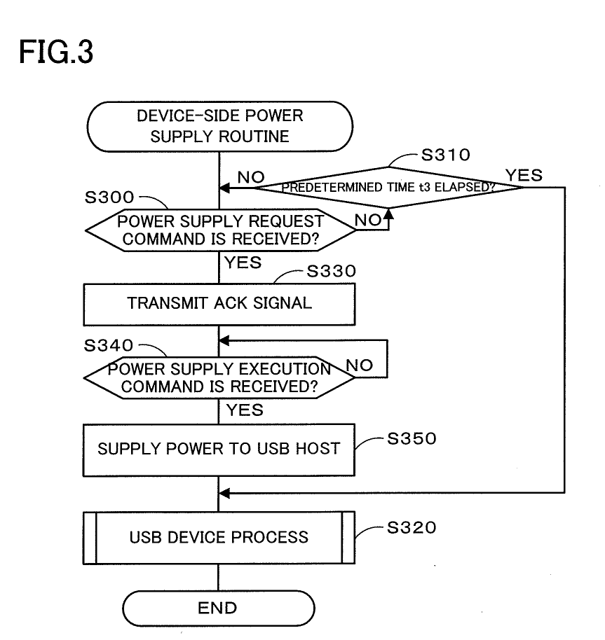

The operation of the USB system 10 having the above configuration according to the embodiment of the present invention, particularly, the operation of the USB system 10 when the USB cable 50 is connected to the print server 20 and the printer 30 will now be described. The USB system 10 operates in the following manner also when the print server 20 and the printer 30 are turned on after the USB cable 50 is connected to the print server 20 and the printer 30. When the user turns on the print server 20 and the printer 30 and connects the USB cable 50 to the connection terminal 26b of the print server 20 and to the connection terminal 36b of the printer 30, the USB controller 26 in the print server 20 performs a host-side power reception routine shown in FIG. 2 and the USB controller 36 in the printer 30 performs a device-side power supply routine shown in FIG. 3. FIG. 2 is a flowchart showing an example of the host-side power reception routine performed by the USB controller 26 in the print server 20. FIG. 3 is a flowchart showing an example of the device-side power supply routine performed by the USB controller 36 in the printer 30. First, the operation of the print server 20 will now be described.

The host-side power reception routine is stored in a memory (not shown) in the USB controller 26 and is executed after the USB device is connected to the connection terminal 26b via the USB cable 50. The connection of the USB device to the connection terminal 26b via the USB cable 50 is detected by the USB controller 26 that confirms each port at predetermined intervals by polling. After the host-side power reception routine is started, in Step S100, the USB controller 26 determines whether the external power unit 28 is connected to an external power supply and whether the print server 20 is capable of operating with the power supplied from the external power supply on the basis of the voltage of the external power unit 28. If the USB controller 26 determines that the external power unit 28 is connected to the external power supply, the USB controller 26 determines that no more power is required and, in Step S110, performs a normal USB host process to supply the power to the USB device through the VBUS line in the USB cable 50. Then, the routine terminates. Specifically, in this normal USB host process, the USB controller 26 supplies the power to the USB device through the VBUS line in the USB cable 50, detects the rate of communication with the USB device on the basis of the state of the two signal lines including the D+ and D− lines, resets the connected ports of the USB device, and performs communication setup with the USB device after the reset state is released. As described above, when the external power supply is connected to the print server 20, the print server 20 functions as the normal USB host.

If the USB controller 26 determines in Step S100 that the external power unit 28 is not connected to the external power supply, then in Step S120, the USB controller 26 transmits a power supply request command to confirm and request power supply to the USB device (the printer 30) through the connection terminal 26b. In this case, the CPU 22 in the print server 20 receives the power from the secondary power unit 27 and operates in the state in which the external power unit 28 is not connected to the external power supply. According to the embodiment of the present invention, signals of a predetermined pattern (for example, the D+ and D− lines are simultaneously pulled up multiple times) are transmitted to the two signal lines as the power supply request command. In Step S130, the USB controller 26 determines whether an acknowledgement (ACK) signal indicating that the power can be supplied to the USB host is received (acquired) from the USB device. If the USB controller 26 determines that the ACK signal is not received, then in Step S140, the USB controller 26 determines whether a predetermined time t1 elapsed, which is empirically calculated and within which a response will be appropriately returned. If the USB controller 26 determines that the predetermined time t1 did not elapse, the USB controller 26 goes back to Step S130, that is, the USB controller 26 enters a standby mode. If the predetermined time t1 elapsed, the USB controller 26 determines that the USB device connected to the USB host does not support the power supply to the USB host and it is difficult for the USB host to continue the processing with the power from the secondary power unit 27. In this case, in Step S150, the USB controller 26 lights up the alarm lamp 25c in red and displays a message indicating switching to the external power supply in the display panel 25a in the display unit 25. In Step S160, the USB controller 26 determines whether the external power supply is connected to the external power unit 28 and the power can be supplied from the external power unit 28. If the USB controller 26 determines that the power can be supplied from the external power unit 28, the USB controller 26 performs Step S110 described above and the routine terminates. This corresponds to a case in which the user watches the information displayed in the display unit 25 and connects the power cord to the external power unit 28. If the USB controller 26 determines in Step S160 that the power cannot be supplied from the external power unit 28, then in Step S170, the USB controller 26 determines whether a predetermined time t2 elapsed, which is set on the basis of the time during which the print server 20 can operate with the power from the secondary power unit 27. If the USB controller 26 determines that the predetermined time t2 did not elapse, the USB controller 26 goes back to Step S160, that is, the USB controller 26 waits until the power can be supplied from the external power unit 28. If the predetermined time t2 elapsed, the USB controller 26 determines that no more processing can be performed with the power from the secondary power unit 27. In this case, in Step S180, the USB controller 26 performs shutdown processing and the routine terminates. As described above, when the USB device connected to the USB host does not support the power supply to the USB host, the USB host prompts the user to switch to the external power supply to allow the subsequent operation.

If the ACK signal is received in Step S130, the USB controller 26 determines that the USB device connected to the USB host can supply the power to the USB host and, in Step S190, transmits a power supply execution command to request execution of the power supply to the printer 30. The ACK signal and the power supply execution command are signals similar to the power supply request command. In Step S200, the USB controller 26 determines whether power is supplied from the printer 30 through the USB cable 50 and the connection terminal 26b. If the USB controller 26 determines that no power is supplied from the printer 30, the USB controller 26 enters the standby mode. If the USB controller 26 determines that power is supplied from the printer 30, then in Step S210, the power supply switching section 26a in the USB controller 26 switches the power supply from the secondary power unit 27 to the printer 30 so that the print server 20 operates with the power supplied from the printer 30 through the VBUS line in the USB cable 50. In Step S220, the USB controller 26 lights up the normal operation lamp 25b in green to indicate to the user that the print server 20 normally operates. In Step S230, the USB controller 26 performs a USB host process in a state in which the USB host receives the power from the USB device while functioning as the USB host. Then, the routine terminates. Step S230 is similar to Step S110 except that the power is supplied from the printer 30 through the VBUS line in the USB cable 50. As described above, when the USB device connected to the USB host supports the power supply to the USB host, the print server 20 operates with the power supplied from the printer 30 through the USB cable 50.

Next, the process in the printer 30 will now be described. The device-side power supply routine shown in FIG. 3 is stored in a memory (not shown) in the USB controller 36 and is executed after the USB host (the print server 20) is connected to the connection terminal 36b via the USB cable 50. After the device-side power supply routine is started, in Step S300, the USB controller 36 determines whether the power supply request command is received from the USB host connected to the connection terminal 36b via the USB cable 50. If the USB controller 36 determines that the power supply request command is not received, then in Step S310, the USB controller 36 determines whether a predetermined time t3 elapsed, which is required to receive the power supply request command. If the predetermined time t3 did not elapse, the USB controller 36 goes back to Step S300, that is, the USB controller 36 enters the standby mode. If the predetermined time t3 elapsed, then in Step S320, the USB controller 36 performs a normal USB device process in which no power is supplied to the USB host connected to the USB device. Then, the routine terminates. In the normal USB device process, the signal line corresponding to the communication rate supported by the printer 30 is pulled up and the ports are reset after a port rest instruction is received from the USB host. When the power is supplied through the VBUS line, the normal USB device process may be performed before the predetermined time t3 elapsed.

If the USB controller 36 determines in Step S300 that the power supply request command is received, then in Step S330, the USB controller 36 transmits the ACK signal indicating that the power can be supplied to the USB host to the print server 20. In Step S340, the USB controller 36 determines whether the power supply execution command is received from the USB host connected to the USB device. If the USB controller 36 determines that the power supply execution command is not received, the USB controller 36 enters the standby mode. If the USB controller 36 determines that the power supply execution command is received, then in Step S350, the USB controller 36 supplies the power to the USB host. Specifically, the power supplying section 36a in the USB controller 36 supplies part of the power received by the external power unit 38 to the USB host through the VBUS line of the connection terminal 36b. In Step S320, the USB controller 36 performs the USB device process described above. Then, the routine terminates. As described above, when the USB host needs the power supply, the printer 30 supplies the power to the USB host through the VBUS line while functioning as the USB device.

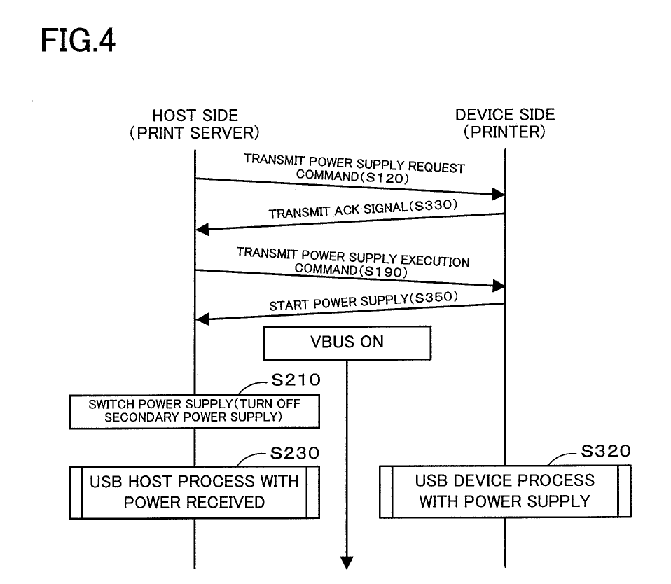

Finally, an exemplary communication process performed between the print server 20 and the printer 30 will now be described with reference to FIG. 4. FIG. 4 is a sequence chart showing an example of the communication process performed in the USB system 10. The step numbers shown in FIG. 4 correspond to the ones shown in FIGS. 2 and 3. The user sets a battery (not shown) in the print server 20 and connects the power cord 38a of the printer 30 to the commercial power supply to turn on the print server 20 and the printer 30. Then, the user connects one end of the USB cable 50 to the connection terminal 26b and the other end thereof to the connection terminal 36b. The print server 20 is activated with the power from the secondary power unit 27 and the printer 30 is activated with the power from the external power unit 38. Referring to FIG. 4, the USB controller 26 in the print server 20 transmits the power supply request command to confirm and request the power supply to the printer 30 (Step S120). The USB controller 36 in the printer 30 receives the power supply request command and transmits the ACK signal indicating that the printer 30 can supply the power to the print server 20 (Step S330). The print server 20 receives the ACK signal and transmits the power supply execution command to request execution of the power supply to the printer 30 (Step S190). The printer 30 receives the power supply execution command and the power supplying section 36a in the printer 30 supplies the power to the print server 20 through the VBUS line in the USB cable 50 (Step S350). As a result, the print server 20 becomes operable with the power supplied through the USB cable 50. The print server 20 switches the power supply to the printer 30 (Step S210) and performs the USB host process in which the power is received from the printer 30, which is the USB device (Step S230). In contrast, the printer 30 performs the USB device process in which the power is supplied to the print server 20, which is the USB host (Step S320). The print data transferred from the user PC 40 to a buffer area in the RAM 24 in the print server 20 is transmitted to the printer 30 under the control of the CPU 22 of the print server 20 functioning as the host. The printer 30 receives the print data and drives the print mechanism 35 to perform printing.

The correspondence between the specific elements disclosed in the embodiments of the present invention and the features of the claims is discussed here. The print server 20 corresponds to the USB host according to the embodiment of the present invention. In the USB host, the connection terminal 26b corresponds to the first connection unit, the secondary power unit 27 and the external power unit 28 correspond to the first power unit, the CPU 22 and the USB controller 26 correspond to the first output unit, the first acquiring unit, and the first control unit, the display unit 25 corresponds to the indicating unit, and the RAM 24 corresponds to the information storage unit. The printer 30 corresponds to the USB device according to the embodiment of the present invention. In the USB device, the connection terminal 36b corresponds to the second connection unit, the CPU 32 and the USB controller 36 correspond to the second output unit, the second acquiring unit, and the second control unit, the power supplying section 36a corresponds to the power supplying unit, the external power unit 38 corresponds to the second power unit, and the print mechanism 35 corresponds to the print processing unit. The power supply request command corresponds to the instruction to request power supply, the ACK signal corresponds to the response indicating that the USB device can supply the power, the printing corresponds to the predetermined process, and the print data corresponds to the processing information and the image information. According to the embodiments of the present invention, the operation of the USB system 10 is described to exemplify the method of controlling the USB host and the method of controlling the USB device.

In the USB system 10 according to the embodiment of the present invention described above, the print server to which one end of the USB cable 50 is connected, the other end of the USB cable 50 being connected to the printer 30, transmits the power supply request command to the printer 30 through the two signal lines in the USB cable 50, the printer 30 receives the power supply request command and transmits the ACK signal to the print server 20, the print server 20 receives the ACK signal and transmits the power supply execution command to the printer 30 through the USB cable 50, the printer 30 receives the power supply execution command and supplies the power to the print server 20 through the VBUS line, and the print server 20 receives the power from the printer 30 and transmits, for example, print data to the printer 30 with the USB controller 26. As described above, since the power supply request command is transmitted through the two signal lines, there is no need to provide another line used to request the power supply. Accordingly, it is possible for the printer 30 to supply the power to the USB host without requiring a dedicated line used for confirming the power supply. Since the print server 20 receives the power after transmitting the power supply request command and receiving the ACK signal, it is possible to reliably receive the power, compared with a case in which the power is received immediately after the request for the power supply. Since the USB cable 50 includes only the two power lines and two signal lines, it is possible to simplify the configuration of the USB cable 50.

Since the print server 20 operates with the power from the secondary power unit 27 before receiving the power from the printer 30, it is possible to ensure the operation of the print server 20 before receiving the power through the USB cable 50. Particularly, since the print server 20 operates with the power from the primary or secondary battery in the secondary power unit 27, it is possible to eliminate the inconvenience of the presence of the power cord. Since information indicating that no power is supplied through the USB cable 50 is displayed in the display unit 25 if no power is supplied from the printer 30 after the print server 20 transmits the power supply request command, the user can easily address the problem of the power that is not supplied from the printer 30. Since the print server 20 includes the external power unit 28, the print server 20 can switch the power supply to the external power unit 28 to ensure the operation of the print server 20 if no power is supplied from the USB device. Since the print server 20 frequently receives the power through the USB cable 50 while functioning as the USB host to output the print data, the application of the present invention is useful. Since the printer 30 includes the external power unit 38 and does not supply the power through the USB cable 50 until the printer 30 receives the power supply request command from the print server 20, it is possible to avoid duplication of the power supply from the power supplying section 36a and the power supply from the USB host supplying the power. Since the printer 30 frequently acquires image data for printing from the USB host through the USB cable 50 to print the acquired image data, the application of the present invention is useful.

It will be further understood by those skilled in the art that the foregoing description is of the preferred embodiments of the present invention and that various changes and modifications may be made to the invention without departing from the spirit and scope thereof.

Although, for example, the power supply request command and the ACK signal are transferred between the print server 20 and the printer 30 through the two signal lines in the USB cable 50 in the embodiments of the present invention described above, the power supply request command and the ACK signal may be transferred therebetween through the two power lines in the USB cable 50. Alternatively, the power supply request command and the ACK signal may be transferred between the print server 20 and the printer 30 through at least one of the two signal lines and at least one of the two power lines to exchange information therebetween.

Although the print server 20 receives the power through the USB cable 50 after transmitting the power supply request command and the power supply execution command in the embodiments of the present invention described above, the print server 20 may receive the power through the USB cable 50 immediately after transmitting the power supply request command. Also in this case, the printer 30 can supply the power to the print server 20 without requiring a dedicated line used for confirming the power supply.

Although the print server 20 is activated with the power from the secondary power unit 27 and, then, operates with the power supplied from the printer 30 in the embodiments of the present invention described above, the print server 20 may be activated with the power from the external power unit 28 and, then, may operate with the power supplied from the printer 30. Also in this case, the printer 30 can supply the power to the USB host without requiring a dedicated line used for confirming the power supply. The print server 20 may display a message indicating that the power cord of the external power unit 28 is to be disconnected in the display panel 25a in the display unit 25 after receiving the power from the printer 30. The disconnection of the power cord of the external power unit 28 can eliminate the inconvenience of the presence of the power cord.

Although the print server 20 includes the secondary power unit 27 and the external power unit 28 in the embodiments of the present invention described above, the print server 20 may include either the secondary power unit 27 or the external power unit 28. This can simplify the configuration of the print server 20. Although the print server 20 includes the display unit 25 in which the lamps are lighted up or any message is displayed in the embodiments of the present invention described above, at least one of the lighting up of the lamps and the display of any message may be omitted or at least one of the display panel 25a, the normal operation lamp 25b, and the alarm lamp 25c in the display unit 25 may not be provided in the print server 20. The omission of at least one of the lighting up of the lamps and the display of any message can simplify the processes. No provision of at least one of the display panel 25a, the normal operation lamp 25b, and the alarm lamp 25c in the display unit 25 can simplify the configuration of the print server 20.

Although the display unit 25 is used to visually indicate information to the user in the embodiments of the present invention described above, a speaker may be provided in the print server 20 to auditorily indicate information to the user. Also in this case, the user can easily react to the indicated information.

Although the printer 30 is described as the USB device in the embodiments of the present invention described above, the printer 30 may function as the USB host. In this case, the printer 30 may be provided with a standard A receptacle as the USB connection terminal and the USB controller 36 may supply the power through the VBUS line as the USB host after confirming that the power supply request command is not supplied from a USB host connected to the connection terminal for a predetermined time. In this case, when the USB host capable of supplying power is connected to the printer 30, it is possible to avoid duplication of the power supply from the USB host connected to the printer 30 and the power supply from the printer 30.

Although the USB cable 50 includes only the two power lines and two signal lines and the connection terminal 26b and the connection terminal 36b can be connected to and disconnected from the USB cable 50 in the embodiments of the present invention described above, the USB cable 50 may further include an ID line and the connection terminal 26b and the connection terminal 36b may be receptacles to which the USB cable 50 can be connected. Also in this case, there is no need to provide a dedicated line used for confirming whether the power supply is needed because the power supply request command is transmitted through either the two power lines or the two signal lines. The USB cable 50 may conform to the USB-OTG.

Although the print server 20 is exemplified as the USB host in the embodiments of the present invention described above, the present invention is applicable to another USB host as long as the USB host needs the power supply from the USB device while functioning as the host. For example, the USB host may be a digital camera, a digital video, a mobile phone, or an external storage device (for example, an HDD or a digital versatile disk (DVD)). In this case, for example, data about a captured image stored in the RAM or a flash memory may be transmitted to the USB device. Although the printer 30 is exemplified as the USB device in the embodiments of the present invention described above, the present invention is applicable to another USB device as long as the USB device can supply the power to the USB host. Particularly, it is preferred that the USB device be a device constantly connected to an external power supply. For example, the USB device may be a scanner apparatus, a PC, a television (TV) set, or a recording deck (for example, an HDD deck, a DVD deck, or a video deck).

The present specification contains the subject matter of Japanese Patent Application No. 2006-355065 filed in Japan on Dec. 28, 2006, the entire disclosed contents of the specification, drawings, and claims of which are incorporated herein by reference.

What is claimed is:

1. A USB host comprising:
a first connection unit capable of being connected to and disconnected from one end of a USB cable including two power lines and two signal lines, the other end of the USB cable being connected to a USB device;
a first output unit that outputs information through the first connection unit; and
a first control unit that causes the first output unit to transmit an instruction to request power supply to the USB device through at least one of the two power lines and the two signal lines in the USB cable and, then, causes the first output unit to transmit information to the USB device with power received from the USB device through the USB cable.

2. The USB host according to claim 1,
wherein the first connection unit is capable of being connected to and disconnected from a USB cable only including two power lines and two signal lines.

3. The USB host according to claim 1, further comprising:
a first acquiring unit that acquires information through the first connection unit,
wherein the first control unit causes the first output unit to output an instruction to execute the power supply through the USB cable when the first acquiring unit acquires a response indicating that the USB device can supply the power from the USB device after the first output unit outputs the instruction to request power supply and, then, causes the first output unit to transmit information to the USB device with the power received from the USB device through the USB cable.

4. The USB host according to claim 1, further comprising:
a first power unit that supplies power from a power source except the USB cable,
wherein the first control unit causes the first output unit to output the information with the power supplied from the first power unit before receiving the power from the USB device through the first connection unit.

5. The USB host according to claim 1, further comprising:
an indicating unit that indicates information to a user,
wherein the first control unit causes the indicating unit to indicate that no power is supplied through the USB cable when no power is supplied from the USB device after the first output unit outputs the instruction to request power supply.

6. The USB host according to claim 1, further comprising:
an information storage unit that stores processing information used for performing a predetermined process,
wherein the first control unit causes the first output unit to transmit the processing information stored in the information storage unit to the USB device through the first connection unit with the power received from the USB device through the USB cable.

7. A USB device comprising:
a second connection unit capable of being connected to and disconnected from one end of a USB cable including two power lines and two signal lines, the other end of the USB cable being connected to a USB host;
a second acquiring unit that acquires information through the second connection unit;
a power supplying unit capable of supplying power through the USB cable; and
a second control unit that causes the power supplying unit to supply the power to the USB host through the USB cable after the second acquiring unit acquires an instruction to request power supply from the USB host through at least one of the two power lines and the two signal lines in the USB cable.

8. The USB device according to claim 7,
wherein the second connection unit is capable of being connected to and disconnected from a USB cable only including two power lines and two signal lines.

9. The USB device according to claim 7, further comprising:
a second output unit that outputs information through the second connection unit,
wherein the second control unit causes the second output unit to transmit a response indicating that the USB device can supply the power to the USB host after the second acquiring unit acquires the instruction to request power supply and, then, causes the power supplying unit to supply the power to the USB host through the USB cable when the second acquiring unit acquires an instruction to execute the power supply through the USB cable.

10. The USB device according to claim 7, further comprising:
a second power unit that supplies power from a commercial power supply,
wherein the second control unit causes the power supplying unit to stop the power supply from the second power unit through the USB cable until the second acquiring unit acquires the instruction to request power supply from the USB host.

11. The USB device according to claim 7, further comprising:
a print processing unit that prints image information on a recording medium,
wherein the second control unit causes the print processing unit to print image information acquired by the second acquiring unit from the USB host through the second connection unit.

12. A method of controlling a USB host including a first connection unit capable of being connected to and disconnected from one end of a USB cable including two power lines and two signal lines, the other end of the USB cable being connected to a USB device, the method comprising the steps of:
(a) transmitting an instruction to request power supply to the USB device through at least one of the two power lines and the two signal lines in the USB cable; and
(b) transmitting information to the USB device with power received from the USB device through the USB cable after the step (a).

13. A method of controlling a USB device including a second connection unit capable of being connected to and disconnected from one end of a USB cable including two power lines and two signal lines, the other end of the USB cable being connected to a USB host, the method comprising the steps of:
(c) acquiring an instruction to request power supply from the USB host through at least one of the two power lines and the two signal lines in the USB cable; and
(d) supplying power to the USB host through the USB cable after the step (c).
